(19) United States
(12) Patent Application Publication
(10) Pub. No.: US 2012/0020910 A1
(43) Pub. Date: Jan. 26, 2012

(54) Compositions for Preserving the Human or Animal Body

(76) Inventors: Jean Sigoure, Mably (FR); Jean-Luc Couturier, Lyon (FR); Jean-Luc Dubois, Millery (FR)

(21) Appl. No.: 13/254,508

(22) PCT Filed: Apr. 2, 2010
(86) PCT No.: PCT/FR2010/050632

§ 371 Date: Oct. 11, 2011

(30) Foreign Application Priority Data
Apr. 7, 2009 (FR) 0952251

(51) Int. Cl. A01N 1/00

(52) U.S. Cl. 424/75

(57) ABSTRACT

The present invention relates to a novel composition, for nontherapeutic purposes, containing at least one POM (PolyOxyMethylene dialkyl ether) and at least one diol. It also relates to the use of this composition for preserving and/or embalming a human or animal body.

The present invention relates to the field of the preservation of human or animal cadavers. More particularly, the invention relates to a novel composition, having a nontherapeutic use, including at least one POM (PolyOxyMethylene dialkyl ether) and at least one specific diol. It also relates to the use, having a nontherapeutic aim, of this composition for preserving and/or embalming a human or animal body.

Embalming of the dead body is a practice asked for by the families of the deceased in order for the body to retain an acceptable appearance until it is buried or cremated. However, under some circumstances, this act may become obligatory, in particular in the cases of movements of bodies across frontiers, of transportation of bodies before cremation in caskets with thinner walls than those intended to be interred, indeed even in the absence of a casket, in some cases of returning to their homes the bodies of people who have died in hospital, and also in some cases of deposition in a temporary grave.

In addition, the hygienic preservation of bodies is the modern and efficient means of avoiding the propagation of diseases by contact between the living and dead, and also the pollution and the contamination of objects and the habitat.

Different compounds are known which are used to embalm and/or preserve human or animal cadavers. In particular, phenol and aldehydes, such as formaldehyde and glutaraldehyde (1,5-pentanedial), are commonly used in this field.

However, these compounds used at high dose are malodorous and toxic and have a tendency to leave treated bodies in a rigid state.

French patent FR 1 457 037 discloses a composition for the preservation of dead animal bodies comprising δ-lactones which comprise an additional oxygen heteroatom in the ring system. This composition can be applied to the cadaver by immersion, by infusion or by injection.

U.S. Pat. No. 5,827,511 describes a composition, injectable by the arterial route, comprising glutaraldehyde, at least one ethanol aromatic ether, at least one moisturizing agent, such as ethylene glycol, and at least one alcohol.

Patent EP 1 127 490 describes a composition comprising at least glycerol and, as active principle, a propolis water/alcohol extract. This composition can be brushed onto the cadaver or injected by the arterial route.

Patent WO2004/093541 discloses an injectable composition comprising ethanedial, also known as glyoxal, and a polar aprotic solvent, such as DMSO (dimethyl sulfoxide), in aqueous solution.

Patent RU 2 116 725 describes a solution based on diethyl acetal (or 1,1-diethoxyethane) for embalming bodies.

The need thus remains to have available nontoxic compositions for embalming which make it possible to efficiently and rapidly preserve bodies without undermining their integrity.

In this context, the Applicant Company filed the French patent application FR 2 910 784, which describes the use of compositions for the preservation and/or embalming of bodies. These compositions comprise POM, and also 200 ml of glycerol, 100 ml of saline solution, 80 ml of soap and 20 ml of dye and of plant essence.

The inventors have now shown that novel compositions including at least one specific POM and at least one specific diol make it possible to obtain even better results than those obtained with the compositions described in the French patent application FR 2 910 784. In particular, the novel compositions according to the invention are much more homogeneous than the preceding compositions, so that it is not necessary to stir the composition before using it. The novel compositions also make it possible to obtain, after application, greater softness of the skin and a better coloring of the skin. This is because, after application, the coloring is more homogeneous and there are no longer regions or patches which are more highly colored than others. In particular, the ears regain a more natural coloring.

Furthermore, the novel compositions according to the invention have little effect on the aesthetic appearance of the body, in particular not increasing, or only to a small extent, the rigidity, the pallor, the emanations of odors and/or the dehydration of the body.

The invention is more specifically targeted at a composition including:

(a) at least one polyoxymethylene dialkyl ether (POM) of formula (I):

R—(OCH₂)ₙ—OR′ (I)

in which R and R′, which are identical, represent a methyl radical and n is an index with a value comprised between 2 and 8,
(b) at least one diol comprising from 2 to 6 carbon atoms and preferably 3 or 4 carbon atoms.

It is understood that, in the context of this description, the term “comprised between” should be interpreted as including the limits indicated.

Within the meaning of the invention, “to preserve” is understood to mean the fact that the enzymatic action is halted or slowed down in human or animal tissue, in comparison with untreated tissue, which prevents or slows down the autocatalytic decomposition of this tissue, and/or that the tissues exhibit better resistance to external attacks of bacteria and mycetae than untreated tissues.

The POMM compounds used according to the invention are PolyOxyMethylene dialkyl ethers which are designated by the acronym POM, for PolyOxyMethylene, to which is added the letter M, making it possible to identify the methyl radicals, and by an index corresponding to the number n of (CH₂O) units.

Thus, these products are denoted POMM, (polyoxymethylene dimethyl ether) when the alkyl is the methyl group, CH₃—(OCH₂)ₙ—OCH₂.

POMMₙ will be used to describe the compound with n oxymethylene (formaldehyde) units. Thus, methylal (n=1) will be known as POMM₂. If a mixture of products resulting from the same synthesis is used, it will be known, for example, as POMM₂₋₈, for a mixture comprising POMMs of n=3 to 8.

The advantages exhibited by the POMs are probably related to their chemical nature, which itself depends on their method of synthesis, by which it is possible to control the chain length. Generally, the boiling point of POMs increases with the number of formaldehyde (CH₂O) units and with the length of the alkyl chain. On the other hand, the solubility in water decreases with the (—CH₂O—)ₙ chain length and with the length of the alkyl chains.

Another advantage of the POMs is their low cost. This is because the synthesis of POMs involves methanol and formaldehyde, itself produced from methanol.

The synthesis of POMs has been well known for many years.

In particular, the book by J. F. Walker, “Formaldehyde”, Robert E. Krieger Publishing Company, Huntington, New York, 3rd edition of 1975, is a reference work on the subject. Specifically, there may be found therein the description of the methods of synthesis on pages 167 et seq., on the one hand, and 264 et seq., on the other hand. These synthetic processes are based on an acid catalysis of the reaction of an alcohol (methanol or ethanol) or of an acetal (methylal or ethylal) with formaldehyde or an equivalent compound. This type of synthesis is also illustrated in numerous patent documents, such as U.S. Pat. No. 2,449,469 or JP 47-40772.

Other synthetic methods based on a catalysis of Lewis acid type have also been described. Mention may be made of the patent document GB 1 120 524, which describes the synthesis of stable polyoxymethylene diethers with ionic catalysts of Lewis acid type.

According to an advantageous embodiment, the invention is targeted at the use of at least one compound chosen from CH₃—(OCH₂)—OCH₃, CH₃—(OCH₂)₂—OCH₃, CH₃—(OCH₂)₃—OCH₃, CH₃—(OCH₂)₄—OCH₃, CH₃—(OCH₂)₅—OCH₃, CH₃—(OCH₂)₆—OCH₃, CH₃—(OCH₂)₇—OCH₃ or CH₃(OCH₂)₈—OCH₃.

According to a preferred embodiment, the invention is targeted at the use of a mixture of compounds of formula R—(OCH₂)ₙ—OR in which R represents a methyl and n ranges from 2 to 8.

According to an even more preferred embodiment, the invention is targeted at the use of at least one compound POMM₂₋₈ which is a mixture of compounds of formula CH₃—(OCH₂)ₙ—OCH₃ with n comprised between 2 and 8, the composition of which is, for example, as follows:

| n | 2 | 3 | 4 | 5 | 6 | 7 | 8 |
|---|---|---|---|---|---|---|---|
| % | 30-55 | 20-40 | 10-20 | 3-10 | 1-5 | <2 | <1 |

More particularly, a preferred composition of a POMM₂₋₈ compound is as follows:

| N | 2 | 3 | 4 | 5 | 6 | 7 | 8 |
|---|---|---|---|---|---|---|---|
| % | 48 | 33 | 12 | 4 | 1.5 | 0.5 | <0.5 |

The POMM compound(s) can represent from 5 to 95% by weight, for example from 50 to 90% by weight, with respect to the total weight of the composition according to the invention. The formulation is subsequently diluted in water to bring it to the concentrations suitable for the body (weight, volume, and the like) to be treated.

According to an advantageous embodiment, the invention is targeted at the use of at least one diol chosen from 1,2-propanediol (or propylene glycol), 1,3-propanediol, 1,2-butanediol, 1,3-butanediol or 1,4-butanediol.

Entirely preferably, the diol employed in the composition according to the invention comprises 3 carbon atoms and is preferably 1,2-propanediol or propylene glycol.

In addition to these compounds, the composition according to the invention can include at least one coloring agent, such as Orange Yellow S, titanium dioxide and/or zinc oxide; at least one aromatizing agent, such as mint, coriander, thyme, citronella, and/or grapefruit; at least one humectant; and their mixtures.

Examples of preferred colored agents are carminic acid (or carmine or cochineal red, E120), azorubine (E122), amaranth (E123), ponceau 4R (or cochineal red A, E124), erythrosine (E127), red 2G (E128), allura red AC (E129), paprika extract (or capsanthin or capsorubin, E160c), lycopene (E160d), apocarotenal (E160e), zeaxanthin (E161h), beetroot red (or betanin, E162), anthocyanins (E163), including grape skin extract (E1631i), blackcurrant extract (E163iii), purple corn colorant (E1631v) or red cabbage dye (E163v), red iron oxide (E1721i), tannic acid (or pigment rubine BK, E180), tannins (E181), Congo red, cresol red, methyl red, phenol red, neutral red, ruthenium red, Sudan red and the mixtures of these.

In addition to these compounds, the composition according to the invention can include at least one biocidal agent.

It is intended to mean, by this expression, in particular the compounds identified as such in EC Regulation No. 1048/2005 of 13 Jun. 2005 as “Active substances for embalming and taxidermist fluids”, namely: formaldehyde, sulfur dioxide, sodium hydrogensulfite, sodium disulfite, sodium sulfite, potassium sulfite, potassium disulfite, bronopol, 1,2-benzisothiazol-3(2H)-one, dodecylguanidine monohydro-chloride, glutaral, methylene dithiocyanate, the mono-hydrochloride of polymer of N,N′″-1,6-hexanediylbis[N′-cyanoguanidine] and hexamethylenediamine/polyhexamethylene biguanide, 2-butanone peroxide, m-phenoxybenzyl 3-(2,2-dichlorovinyl)-2,2-dimethylcyclopropane-carboxylate/permethrin, quaternary ammonium chlorides, bis(trichloromethyl)sulfone, boric acid, N,N-diethyl-m-toluamide or 2-methyl-2H-isothiazol-3-one. Use may also be made, as biocides, of the compounds of formula (C₃H₄O)ₙ.(C₃H₄O₂)ᵣₙ where n>m, such as Chemyde® from Chemeq, and also polyvinylpyrrolidone-iodine, available in particular from Graymor Chemical Hamburg and described in the patent application EP 1 365 646, and their mixtures.

These biocidal agents are generally present in a low amount in the composition according to the invention. They thus represent, for example, from 2 to 90% by weight, preferably from 4 to 50% by weight, with respect to the total weight of the composition. Before use, the composition can be diluted by the embalmer so that the concentration of biocidal agent is, for example, comprised between 0.2 and 80% by weight.

The composition according to the invention can also include at least one propenetrating agent.

This expression is understood to mean the agents (other than water) which promote the penetration of the composition into the body, through the sudoriferous ducts, via the hair follicles or sebaceous glands, or else through the stratum corneum and even into the dermis. Propenetrating agents of the latter type are preferred for use in the present invention. These agents can increase the permeability of the stratum corneum, for example by dissolving or disarranging the intracellular biolayer lipid structure or by acting with the intracellular proteins or by improving the coefficient of distribution of the POMMs in the stratum corneum. In an alternative form, the propenetrating agents can act as vectors which improve the transportation of the POMM compounds through the stratum corneum.

Propenetrating agents which can be used in the present invention are in particular: linear or branched C₂-C₆ monoalcohols, such as ethanol or n-butanol; polyols, such as propylene glycol, glycerol, dipropylene glycol and polyethylene glycol; C₈-C₂₂ fatty acids, preferably mono- or polyunsaturated fatty acids, such as oleic, linoleic, lauric, caprylic or capric acid; cyclodextrins; isosorbide and isosorbide derivatives, such as dimethyl isosorbide (see the application US 2008/0003273) and isosorbide dinitrate; surfactants, including sucrose fatty acid esters, such as sucrose oleate, sorbitan fatty acid esters, ethers of fatty alcohols and of polyethylene glycol (PEG), such as PEG oleyl ethers, polyethoxylated hydrogenated castor oils and phospholipids, such as lecithin; esters, such as C₁-C₄ alkyl acetates, mono- and polyesters of fatty acid and of glycerol or of propylene glycol, such as glycerol monolaurate or trioleate, esters of fatty alcohols and of lactic acid or of glycolic acid and esters of fatty acids and of isopropanol; C₈-C₁₈ fatty alcohols, such as n-nonanol, oleyl alcohol and lauryl alcohol; azones, such as N-alkylazacycloheptan-2-one; alkyl N,N-dialkylaminoalkanoates, such as dodecyl 2-(N,N-dimethylamino)propionate (DDAIP); amides, such as N,N-diethyl-m-toluamide; urea and urea derivatives, such as allantoin; terpenes and terpenoids, such as essential oils, for example menthol, thymol and camphor; methyl or benzyl nicotinate; sulfoxides, such as DMSO (dimethyl sulfoxide) or decyl methyl sulfoxide; and their mixtures.

Other examples of propenetrating agents are mentioned by Osborne et al. in the paper “Skin penetration enhancers cited in the technical literature”, published in Pharmaceutical Technology (November 1997). Mixtures of monoalcohols or of cyclodextrins with other propenetrating agents are particularly useful. Furthermore, it is preferable for the propenetrating agents according to the invention not to comprise pyrrolidones (such as N-methyl-2-pyrrolidone).

In some cases, in order to improve the penetration of the composition into the skin, the propenetrating agent can be used to encapsulate the POMMs in vesicles, such as liposomes, niosomes or nanocapsules, or to form complexes starting from these compounds. It is thus possible, in particular, to form inclusion complexes of these active compounds with a cyclodextrin.

The propenetrating agents can, for example, represent from 1 to 80% by weight, preferably from 5 to 70% by weight, with respect to the total weight of the composition. According to one embodiment of the invention, they can be present in a ratio with the POMMs which makes it possible to obtain a eutectic mixture.

This composition can be provided in any formulation form suitable for topical application to the skin, in particular in the form of a solution, emulsion or gel. It can have a liquid, semiliquid or solid consistency and can thus be provided in the form of a lotion, fluid, cream, paste or indeed even foam. This composition can optionally be packaged in a pump-action spray or an aerosol device.

Another subject matter of the invention is the topical use of the abovementioned composition for the preservation of the human or animal body.

In an advantageous embodiment, the body can be immersed in the composition. In another advantageous embodiment, the composition can be applied to the body by the topical route, in particular by brushing. It is also possible according to the invention to improve the transdermal penetration of the composition by the use of one or more techniques, such as ionophoresis, electroporation, sonophoresis or phonophoresis, as described in particular by Cross et al. in Curr. Drug Delivery, 2004, 1, 81-92, by Barry et al. in Eur. J. Pharm. Sci., 2001, 14, 101-14, or by Tao et al. in Adv. Drug Delivery Rev., 2003, 55, 315-28.

The composition according to the invention can also include at least one antiseptic agent.

According to an advantageous embodiment, the composition comprises 50-95% by volume of at least one compound of formula (I), 5-50% by volume of propylene glycol and 0-5% by volume of at least one coloring agent.

Another subject matter of the invention is a process for preserving a human or animal body and/or embalming a dead body comprising the administration to the body of a composition comprising at least one POMM and at least one diol as defined above.

Advantages of the process according to the invention are the speed of execution, that is to say that the rate of declotting is high, and also the speed of care.

In a first advantageous embodiment, the composition is injected into the body by the intra-arterial route.

Preferably, the composition injected by the arterial route is an aqueous solution, the concentration of POMM of which ranges from 1 to 25% by weight. More preferably still, the composition is injected pure into the cavity.

In a second advantageous embodiment, the composition is perfused into the body.

In a third advantageous embodiment, the body is immersed in the composition.

In a fourth advantageous embodiment, the composition is applied to the body by the topical route.

These methods of administration are well known to a person skilled in the art.

The invention will now be illustrated by the following nonlimiting examples, which do not have the aim of limiting the scope of the invention defined by the appended claims.

### EXAMPLES

### Example 1

### Not in Accordance with the Invention

800 g of POM-M-2.8, of the following composition:

| N | 2 | 3 | 4 | 5 | 6 | 7 | 8 |
|---|---|---|---|---|---|---|---|
| % | 48 | 33 | 12 | 4 | 1.5 | 0.5 | <0.5 |

and 200 g of glycerol are mixed. The mixture remains a two-phase mixture.

It could be used in embalming only with vigorous stirring.

### Example 2

### Not in Accordance with the Invention

300 ml of POM-M-2.8 with the composition of example 1, diluted in 7.2 liters of water, are injected with an electric pump into the femoral artery of the mortal remains of a man weighing 80 kg, followed by the injection of 500 ml of POM-M-2.8 into the cavity. The total volume drained during the arterial injection is 6 liters.

After 4 days at ambient temperature, the preservation of the body is good but it is observed that the skin is dry and rigid, in particular at the nose.

### Example 3

### In Accordance with the Invention

900 g of POM-M-2.8 with the composition of example 1 and 100 g of 1,2-propanediol are mixed.

200 ml of the mixture, diluted in 4.3 liters of water, are injected with an electric pump into the femoral artery of the mortal remains of a woman weighing 40 kg, followed by the injection of 500 ml of the mixture into the cavity. The total volume drained during the arterial injection is 3 liters. The diffusion of the product into the body is excellent. The skin appears hydrated and supple. After 4 days at ambient temperature, the preservation of the body is good and the suppleness and the hydration of the skin are maintained.

1. A composition comprising
(a) at least one polyoxymethylene dialkyl ether (POM) of formula (I):
R—(OCH₂)ₙ—OR′ (I)
wherein R and R′ are identical, represent a methyl radical and n is an index with a value between 2 and 8, and
(b) at least one diol comprising from 2 to 6 carbon atoms and preferably 3 or 4 carbon atoms.

2. The composition as claimed in claim 1, wherein the compound of formula (I) is chosen from: CH₃—(OCH₂)—OCH₃, CH₃—(OCH₂)₂—OCH₃, CH₃—(OCH₂)₃—OCH₃, CH₃—(OCH₂)₄—OCH₃, CH₃—(OCH₂)₅—OCH₃, CH₃—(OCH₂)₆—OCH₃, CH₃—(OCH₂)₇—OCH₃, CH₃—(OCH₂)₈—OCH₃ and their mixtures.

3. The composition as claimed in claim 1, wherein the compound of formula (I) is a compound POMM₂₋₈ which is a mixture of compounds of formula CH₃—(OCH₂)ₙ—OCH₃ with n between 2 and 8.

4. The composition as claimed in claim 1, wherein the diol comprises 3 carbon atoms and is preferably propylene glycol.

5. The composition as claimed in claim 1, and further comprising at least one agent chosen from a coloring agent, a biocidal agent, a propenetrating agent and their mixtures.

6. A composition comprising 50-95% by volume of said compound as claimed in claim 1, 5-50% by volume of propylene glycol and 0-5% by volume of at least one coloring agent and/or aromatizing agent.

7. A process for preserving and/or embalming a body of a human or an animal which comprises administering to said body of a composition as claimed in claim 1.

8. The process as claimed in claim 7, wherein the composition is injected into said body by the intra-arterial route.

9. The process as claimed in claim 7, wherein the composition is perfused into said body.

10. The process as claimed in claim 7, wherein the composition is applied to said body by the topical route.
